(19) United States
(12) Patent Application Publication
(10) Pub. No.: US 2020/0219008 A1
(43) Pub. Date: Jul. 9, 2020

(54) DISCRETE LEARNING STRUCTURE

(71) Applicant: NEC Laboratories Europe GmbH, Heidelberg (DE)

(72) Inventors: Luca Franceschi, Heidelberg (DE); Xiao He, Heidelberg (DE); Mathias Niepert, Heidelberg (DE)

(21) Appl. No.: 16/558,175

(22) Filed: Sep. 2, 2019

Related U.S. Application Data
(60) Provisional application No. 62/790,041, filed on Jan. 9, 2019.

(51) Int. Cl. G06N 20/00; G06N 7/00

(52) U.S. Cl. CPC G06N 20/00; G06N 7/005

(57) ABSTRACT

A computer-implemented method can include providing a data set arranged into multiple nodes and assigning a random variable and a hyper-parameter to at least one pair of the multiple nodes. The hyper-parameter can define a current probability distribution of the random variable. The method can further include: causing the random variable to occupy a discrete state based on the current probability distribution; sampling a graph structure for the data set based on the discrete state; adjusting a weight of a prediction model based on the sampled graph structure; estimating a gradient of the hyper-parameter based on the sampled graph structure and the adjusted weight; adjusting the hyper-parameter based on the estimated gradient; resampling a graph structure for the data set based on the adjusted hyper-parameter; and assigning a final graph structure to the data set based on the resampled graph structure.

### CROSS-REFERENCE TO RELATED APPLICATION

The present application claims priority to U.S. Provisional Patent Application No. 62/790,041, filed on Jan. 9, 2019, the entire contents of which are hereby incorporated by reference herein.

### FIELD

The present invention relates to machine learning. The machine learning can be directed to graph structures and graph-based parametric models.

### BACKGROUND

A graph can illustrate relationships within data by organizing the data into a series of nodes and edges. The edges can represent links between the nodes. Each edge can be weighted to quantify the strength or weakness of the link. A convolutional neural network is an example of a graph where the nodes represent neurons and the edges represent weighted (and often unidirectional) neuron interconnections.

Some machine learning models operate on an input graph. For example, a graph convolutional network (GCN) can accurately classify documents when given an input citation network in graph form. See, for example, Kipf and Welling, “Semi-Supervised Classification with Graph Convolution Networks,” arxiv:1609.02907v4 (Feb. 22, 2017), which is hereby incorporated by reference. Among other things, Kipf and Welling discuss a scalable approach for semi-supervised learning on graph-structured data. The approach is based on an efficient variant of convolutional neural networks that operate directly on graphs. The choice of convolutional architecture can be driven via a localized first-order approximation of spectral graph convolutions.

As another example, multi-task learning (MTL) often performs better when the input task relationship is modeled as a graph. See, for example, He et al., “Efficient and Scalable Multi-task Regression on Massive Number of Tasks,” arxiv:1811.056 (Nov. 14, 2018), which is hereby incorporated by reference. He et al. discusses formulating real-world large-scale regression problems as MTL problems with a massive number of tasks. An algorithm is disclosed that can integrate with graph-based convex clustering.

### SUMMARY

A computer-implemented method can include: providing a data set arranged into multiple nodes; assigning a random variable and a hyper-parameter to at least one pair of the multiple nodes, the hyper-parameter defining a current probability distribution of the random variable; causing the random variable to occupy a discrete state based on the current probability distribution; sampling a graph structure for the data set based on the discrete state; adjusting a weight of a prediction model based on the sampled graph structure; estimating a gradient of the hyper-parameter based on the sampled graph structure and the adjusted weight; adjusting the hyper-parameter based on the estimated gradient; resampling a graph structure for the data set based on the adjusted hyper-parameter; and assigning a final graph structure to the data set based on the resampled graph structure.

### BRIEF DESCRIPTION OF THE DRAWINGS

Embodiments of the present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIGS. 1A and 1B show a graph structure according to an embodiment of the present invention;

FIG. 2 is a block diagram of an embodiment of a method according to the present invention;

FIG. 3 is a block diagram of an embodiment of a method according to the present invention; and

FIG. 4 is a block diagram of an embodiment of a processing system for performing the exemplary methods according to the present invention.

### DETAILED DESCRIPTION

Among other things, the present invention discloses techniques for assigning structure to unstructured data and for improving the structure of previously structured data. To do so, embodiments of the present invention can arrange a data set into a series of nodes. Edges can be defined between the nodes according to a probabilistic distribution. Graphs can be randomly sampled from the probabilistic distribution. Embodiments of the present invention can evaluate the randomly sampled graphs to determine (e.g., estimate) the impact of the edges on graph efficiency and/or accuracy. The results of the evaluation can be used to adjust (i.e., improve) the probabilistic distribution. The cycle can be repeated until the optimum probabilistic distribution is obtained (i.e., the results converge).

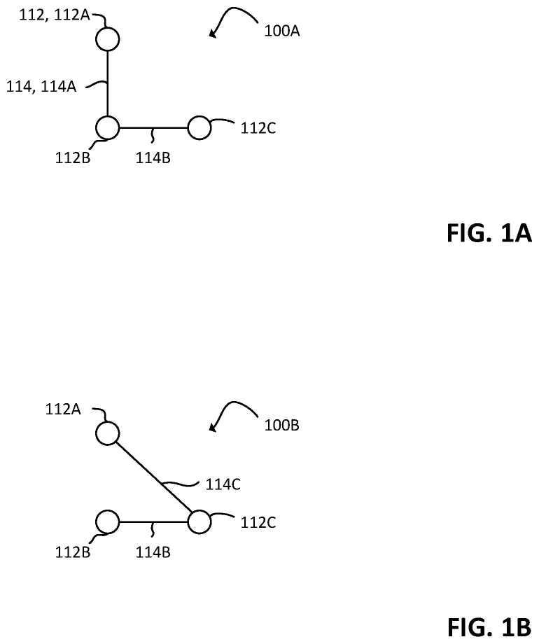

An example graph appears in FIG. 1. As shown in FIGS. 1A and 1B, a graph can include nodes 112 and edges 114. Nodes 112 can represent objects (e.g., people, organizations, cities, products, images, neurons in a neural network) while edges 114 can represent links (e.g., transactions, relationships, routes, citations, weighted interconnections between neural network neurons) between nodes 112. In the first graph 100A shown in FIG. 1A, first edge 114A is a link between first node 112A and second node 112B. Second edge 114B is a link between second node 112B and third node 112C. Edges can be bidirectional or unidirectional.

The arrangement and properties of edges 114 can define the structure of a graph. The structure shown in FIG. 1A, for example, is only one graph structure given nodes 112A, 112B, 112C. The second graph 100B of FIG. 1B adds a third edge 114C extending directly between first node 112A and third node 112C while subtracting first edge 114A.

An embodiment of the present invention provides a processing system that can be configured to structure data into a graph. For example, the processing system can be configured to accept, as an input, an unstructured set of data. The processing system can structure the data into a set of nodes (e.g., nodes 112) and a set of edges (e.g., edges 114). By formatting the data into a graph, the processing system can enable a graph-based machine learning model to operate on the data. Put differently, the processing system can be configured to enable machine learning on previously inaccessible data sets.

Besides assigning structure to disorganized (i.e., unstructured) data, the processing system can be configured to improve the structure of existing graphs, such as existing neural networks (e.g., existing convolutional neural networks). The processing system can be configured to restructure graphs, such as neural networks, so by adding new edges or by modifying (e.g., reweighting, deleting, etc.) existing edges. By removing and adjusting existing edges, the processing system can simplify existing graphs while preserving accuracy. By reducing computational load, simplified graphs can conserve processing resources and consume less memory.

As discussed above, an embodiment of the present invention provides a processing system that can be configured to jointly learn probabilistic graph structures and graph based parametric models. The processing system can be applied when the appropriate graph structure for a set of data is unknown. The processing system can adapt the kind of graph structure applied to downstream prediction tasks (e.g., document classification).

According to some embodiments, the processing system can model the presence of each edge in a graph as a random (e.g., pseudo-random) variable. The parameter of the random variable (e.g., a Bernoulli random variable) can be treated as a hyper-parameter in a multi-level (e.g., bilevel) learning framework. See, for example, Franceschi et. al, “Bilevel Programming for Hyperparameter Optimization and Meta-Learning,” arXiv:1806.04910v2 (Jul. 3, 2018), which is hereby incorporated by reference.

The processing system can iteratively sample graph structure while minimizing an inner objective with respect to model parameters and specifically optimizing Bernoulli parameters by minimizing a relevant outer objective. Through the above operations, the processing system can be configured to learn the graph of samples, features, and output space for machine learning models (e.g., a graph neural network). The processing system can be configured to learn graph structures and machine learning models simultaneously, so that problems without a given graph can benefit from graph-based machine learning models.

Advantageously, the processing system can be configured to learn a discrete structure of data without relaxing (also called “overfitting”). Relaxing or overfitting occurs when edges (e.g., edges 114) are added between nodes (e.g., nodes 112) until a fully-connected graph results. By doing so, the processing system can improve model performance, gain insight from the learned discrete structure, and apply graph-based techniques to novel domains.

As previously discussed, the processing system can be configured to search a sparse computational graph for a neural network (e.g., restructure a dense neural network into a sparse neural network). In some instances, the processing system can produce a sparse neural network from a dense neural network where the sparse neural network has the same or similar prediction accuracy as the dense neural network (e.g., within ten percent), but only ten percent of the weights (e.g., neuron interconnections) of the dense neural network. This technique enables the usage of neural networks in devices with limited memory and computational resources. See, for example, Han et al, “Learning both Weights and Connections for Efficient Neural Networks,” arXiv:1506.02626v3 (Oct. 30, 2015), which is hereby incorporated by reference.

According to an embodiment of the invention, a computer-implemented method can include: providing a data set arranged into multiple nodes; assigning a random variable and a hyper-parameter to at least one pair of the multiple nodes, the hyper-parameter defining a current probability distribution of the random variable; causing the random variable to occupy a discrete state based on the current probability distribution; sampling a graph structure for the data set based on the discrete state; adjusting a weight of a prediction model based on the sampled graph structure; estimating a gradient of the hyper-parameter based on the sampled graph structure and the adjusted weight; adjusting the hyper-parameter based on the estimated gradient; resampling a graph structure for the data set based on the adjusted hyper-parameter; and assigning a final graph structure to the data set based on the resampled graph structure.

According to the exemplary method, the random variable can be a Bernoulli variable configured to occupy a first discrete state and a second discrete state with a frequency based on a value of the hyper-parameter.

According to the exemplary method, the first discrete state can correspond to a presence of an edge extending between the pair of nodes and the discrete second state can correspond to an absence of an edge extending between the pair of nodes.

According to the exemplary method, a random variable and a hyper-parameter defining a current probability distribution of the random variable are assigned to each possible pair of the multiple nodes such that a total quantity of the random variables is equal to a total quantity of the hyper-parameters, which exceeds a total quantity of the nodes.

According to the exemplary method, providing the data set arranged into multiple nodes can include: preprocessing an unstructured data set, the preprocessing comprising data normalization; extracting features from the preprocessed data set and assigning each of the extracted features to one or more nodes based on a location from which the feature was extracted.

According to the exemplary method, the causing of the random variable to occupy the discrete state, the sampling of the graph structure, and the adjusting of the prediction model weight can define an inner loop and the method can include: performing the inner loop multiple times such that the weight of the prediction model is adjusted multiple times based on multiple sampled graph structures; and estimating the gradient of the hyper-parameter based on the multiple sampled graph structures and the multiple adjustments to the weight.

According to the exemplary method, the prediction model can be a neural network and the method can include classifying a subsequent data set with the neural network.

According to the exemplary method, the prediction model can be a neural network including neurons and the weight of the neural network can be adjusted by training the neural network with a predetermined set of training data.

According to the exemplary method, the gradient of the hyper-parameter can be defined with respect to a cost function of the neural network.

According to an embodiment of the invention, a processing system can include one or more processors configured to: provide a data set arranged into multiple nodes; assign a random variable and a hyper-parameter to at least one pair of the multiple nodes, the hyper-parameter defining a current probability distribution of the random variable; cause the random variable to occupy a discrete state based on the current probability distribution; sample a graph structure for the data set based on the discrete state; adjust a weight of a prediction model based on the sampled graph structure; estimate a gradient of the hyper-parameter based on the sampled graph structure and the adjusted weight; adjust the hyper-parameter based on the estimated gradient; resample a graph structure for the data set based on the adjusted hyper-parameter; and assign a final graph structure to the data set based on the resampled graph structure.

According to the exemplary processing system, the one or more processors can be configured to cause the random variable to occupy a first discrete state and a second discrete state with a frequency based on a value of the hyper-parameter.

According to the exemplary processing system, the one or more processors can be configured such that the first discrete state corresponds to a presence of an edge extending between the pair of nodes and the discrete second state corresponds to an absence of an edge extending between the pair of nodes.

According to the exemplary processing system, the one or more processors can be configured such that a random variable and a hyper-parameter defining a current probability distribution of the random variable are assigned to each possible pair of the multiple nodes such that a total quantity of the random variables is equal to a total quantity of the hyper-parameters, which exceeds a total quantity of the nodes.

According to the exemplary processing system, the one or more processors can be configured to provide the data set arranged into the multiple nodes by: (a) receiving the data set arranged into the multiple nodes through a communications platform, or (b) preprocessing an unstructured data set, the preprocessing comprising data normalization; and extracting features from the preprocessed data set and assigning each of the extracted features to one or more nodes based on a location from which the feature was extracted.

According to an embodiment of the invention, a computer program can be present (i.e., embodied) on at least one non-transitory computer-readable medium. The exemplary computer program can include instructions (e.g., script code) to cause one or more processors to: provide a data set arranged into multiple nodes; assign a random variable and a hyper-parameter to at least one pair of the multiple nodes, the hyper-parameter defining a current probability distribution of the random variable; cause the random variable to occupy a discrete state based on the current probability distribution; sample a graph structure for the data set based on the discrete state; adjust a weight of a prediction model based on the sampled graph structure; estimate a gradient of the hyper-parameter based on the sampled graph structure and the adjusted weight; adjust the hyper-parameter based on the estimated gradient; resample a graph structure for the data set based on the adjusted hyper-parameter; and assign a final graph structure to the data set based on the resampled graph structure.

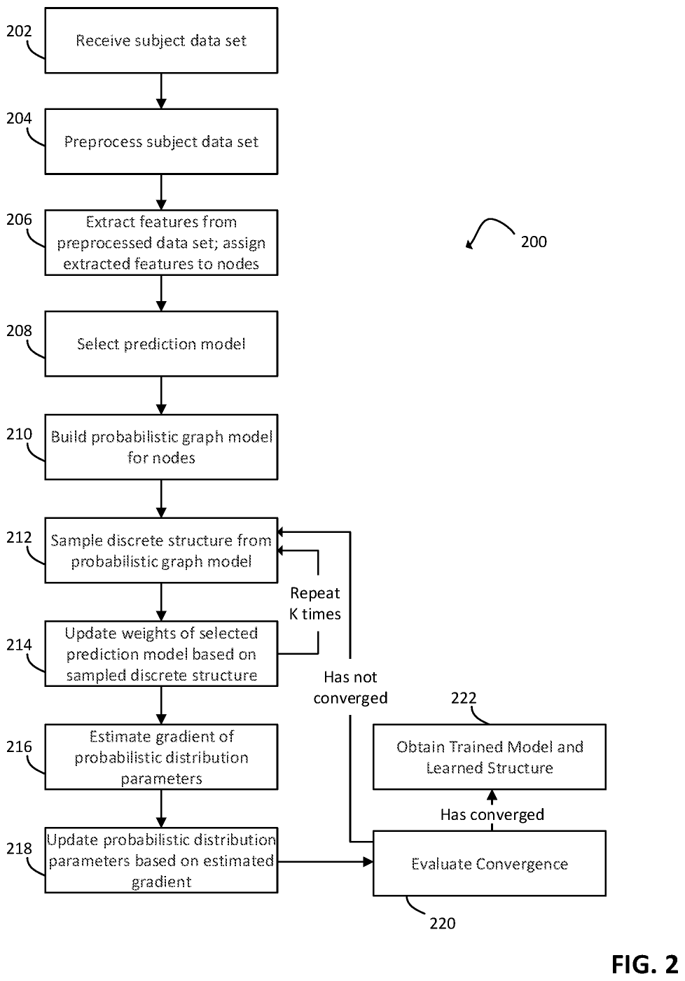

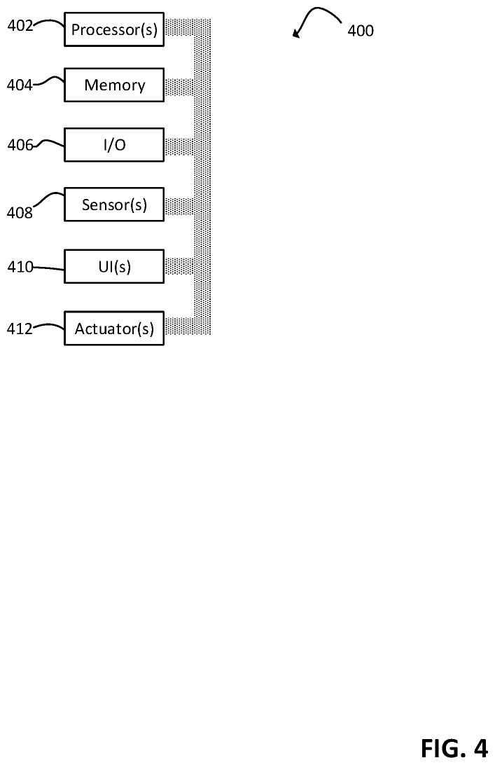

FIG. 2 presents a method 200 for structuring data into a graph according to an embodiment of the present invention. The data can begin as unstructured. Alternatively, the data can begin as a first graph and method 200 can restructure the data into a second graph. For example, the data can begin as a neural network with multiple fully connected layers (i.e., exhibit dense connections between neurons). Method 200 can restructure the neural network by modifying edges 114 (e.g., the interconnections between neurons). The restructured neural network (i.e., the second or output graph) can exhibit sparse connections between neurons while retaining the predictive power of the original neural network. As with all operations disclosed herein, a processing system 400 (see FIG. 4) can be configured to perform method 200.

At block 202, processing system 400 can start by receiving a set of subject data. As discussed above, the subject data can be arranged in an original graph or be unstructured. At block 204, processing system 400 can preprocess the subject data. During preprocessing, processing system 400 can organize the subject data into nodes according to natural groupings within the subject data. For example, if the subject data is a collection of documents, processing system 400 can assign a separate node to each document, to each chapter, or to each sentence. If the subject data are financial transactions, processing system 400 can assign a separate node to each transacting entity (e.g., each person) or to each transacting account. Furthermore, processing system 400 can normalize the subject data during preprocessing. For example, processing system 400 can remove corrupt values.

At block 206, processing system 400 can perform feature extraction on the preprocessed data. Features can be assigned to the node from which they were extracted. Features can be a predetermined set of objects or properties. For example, if the subject data includes documents, then features can be words. In some embodiments, feature extraction can operate according to a “bag of words” model, where every word in a document is recognized as a feature. As another example, if the subject data includes transactions between entities, then features can include account balances, account numbers, names of account holders, etc.

At block 208, processing system 400 can select (i.e., determine) a prediction model. Here, processing system 400 can choose a predication model that accepts a graph as an input, such as a graph convolutional network, graph regularized multi-task learning, and a sparse neural network. In some embodiments, the prediction model can be configured to non-graph inputs. For example, the prediction model can be a convolutional neural network configured to classify and/or encode images. At block 210, processing system 400 can build a probabilistic graph model. For example, processing system 400 can assign a probabilistic random variable (e.g., a Bernoulli random variable) to each potential pairing of nodes 112. In the example of FIGS. 1A and 1B, where only bidirectional edges are enforced, there are three possible node pairings: A first pair between first node 112A and second node 112B, a second pair between first node 112A and third node 112C, and a third pair between second node 112B and third node 112C. In other embodiments where, for example, edges can be unidirectional, three nodes can define more than three (e.g., six) possible pairings.

The random variable can be configured to occupy only one of two states: an ON state (i.e., a first state) and an OFF state (i.e., a second state). When the random variable occupies the ON state, processing system 400 can extend an edge directly between the corresponding pair of nodes. When the random variable occupies the OFF state, processing system 400 can eliminate any edge extending directly between the corresponding pair of nodes 112. Therefore, FIG. 1A can illustrate a sample of a graph occurring when the random variable assigned to first edge 114A occupies the ON state, the random variable assigned to second edge 114B occupies the ON state, and the random variable assigned to third edge 114C occupies the OFF state. Similarly, FIG. 1B can illustrate a sample of a graph occurring when the random variable assigned to second edge 114B switches to the OFF state while the random variable assigned to third edge 114C switches to the ON state.

Each variable can have a hyper-parameter with a range [0, 1] or (0, 1). When the hyper-parameter is 0, the variable can be OFF with 100% frequency. When the hyper-parameter is 0.5, the variable can be randomly ON or OFF with 50% probability of being ON and 50% probability of being OFF. When the hyper-parameter is 1.0, the variable can ON with 100% frequency. Processing system 400 can initialize each hyper-parameter equally (e.g., at 0.5). As discussed below, processing system 400 can iteratively adjust the hyper-parameters according to their respective gradients.

Referring to the example of FIGS. 1A and 1B, processing system 400 can initialize the three hyper-parameters respectively corresponding to first, second, and third edges 114A, 114B, 114C at 0.5. After multiple iterations of method 200, each of the hyper-parameters can converge to a different value. For example, the hyper-parameter corresponding to first edge 114A can converge to 0.1 while the hyper-parameter corresponding to second edge 114B converges to 0.5 and the hyper-parameter corresponding to third edge 114C converges to 0.9.

At blocks 212-220, processing system 400 can learn (i.e., update) hyper-parameters for the probabilistic model. At block 212, processing system 400 can sample a discrete structure from a probabilistic distribution based on the latest hyper-parameters. For example, processing system 400 can randomly place each variable in an ON or OFF state based on the latest hyper-parameter corresponding to the variable. Put differently, sampling can occur when a graph (e.g., adjacency matrix) is constructed by sampling a state of each random variable from the respective probability distribution defined by the respective hyper-parameter. As stated above, an edge can be constructed between each pair of nodes when the variable corresponding to the pair of nodes occupies the ON state. Therefore, if each hyper-parameter is 0.5, then, on average, approximately half all possible edges will exist and approximately half of all possible edges will be absent.

At block 214, processing system 400 can update the weights of the prediction model (selected during block 208) based on the discrete structure sampled during block 212. According to some embodiments, the weights of the prediction model are updated using gradient descent where the derivative of a loss function (e.g., a cost function) is computed with respect to the parameters (i.e., weights) of the prediction model. Processing system 400 can update the weights in the direction of the gradient. When the prediction model accepts graph as an input, then the loss function can rely on training data in the form of the sampled graphs. When the prediction model accepts external data (e.g., images) as an input, the loss function can rely on external training data (e.g., known pairings between input images and respective classifications and/or encodings).

As another example, processing system 400 can configure the prediction model (e.g., neural network) to have a structure (e.g., set neuron interconnections) based on the sampled discrete structure. Processing system 400 can train the restructured prediction model through, for example, supervised learning with predetermined training data (e.g., known input/known output pairs). As stated above, the predetermined training data can be sampled graphs. During supervised learning, processing system 400 can update the weight assigned to each neuron interconnections to minimize a cost function (also called a training error).

Processing system 400 can be configured to repeat blocks 212 and 214 a predetermined amount of times K, where the predetermined amount K can be an adjustable parameter greater than 1.

At block 216, processing system 400 can estimate the gradient of parameters of the probabilistic distribution based on the structures sampled over the instances of block 212, learning dynamics, and the iterates of the model weights obtained over the instances of block 214. For example, processing system 400 can determine an association between the set of hyper-parameters and the cost function. Since block 216 will occur multiple times (further discussed below), processing system 400 can estimate (i.e., determine) one or more gradients of the probabilistic parameters (e.g., the hyper-parameters) with respect to properties of the model (e.g., the cost function or the set of weights). Each iteration of block 216 can improve accuracy of the one or more gradients.

Block 214 can represent an inner objective while block 216 can represent an outer objective. Within the inner objective, processing system 400 can compute the gradients of the parameters (i.e., weights) of the prediction model (e.g., a graph convolutional network) with respect to an error function. Processing system 400 can update the parameters (i.e., weights) of the prediction model to minimize the error function (e.g., cost function). Within the outer objective, processing system 400 can compute gradients of the hyper-parameters with respect to the error function. Processing system 400 can update the hyper-parameters to minimize the error function.

At block 218, processing system 400 can update the parameters of the probabilistic distribution (e.g., the hyper-parameters) based on the gradients estimated during block 216. Processing system 400 can apply the gradients to update the hyper-parameters in a manner expected to improve the properties of the model (e.g., the cost function). At block 220, processing system 400 can determine whether the parameters of the Bernoulli distribution (e.g., the hyper-parameters) have converged and/or whether the properties of the model have converged (e.g., whether the cost function has converged to a local minimum).

Upon evaluating (i.e., determining) that convergence has occurred, processing system 400 can advance to block 222. Otherwise, processing system 400 can return to block 212 for a subsequent instance of block 210. Processing system 400 can repeat block 210 until convergence occurs. Processing system 400 can determine that convergence has occurred during an instance of block 220 when the cost function (i.e., the error function) of the prediction model improves by less than a predetermined value (e.g., by less than 1%) over the previous instance of block 220.

At block 222, processing system 400 can obtain a trained model and learned structure by sampling the structure from the learned probabilistic distribution. One of the trained model and learned structure can be a graph generative model that processing system 400 can sample graphs from. The other of the trained model and learned structure can be a graph convolutional network for processing external data.

The trained final model can be obtained by empirically averaging several sampled models. For example, if processing system 400 determines that block 210 converged onto set S1 of hyper-parameters (e.g., set S1 of hyper-parameters minimized the cost function), then processing system 400 can produce multiple models, each model being based on set S1 of hyper-parameters. Processing system 400 can average the multiple models to obtain the final model (i.e., processing system 400 can extract a final model based on the multiple models). The final model can be a graph of interconnections between neurons in a neural network. Put differently, the final model can be a restructured version of the prediction model selected at block 208.

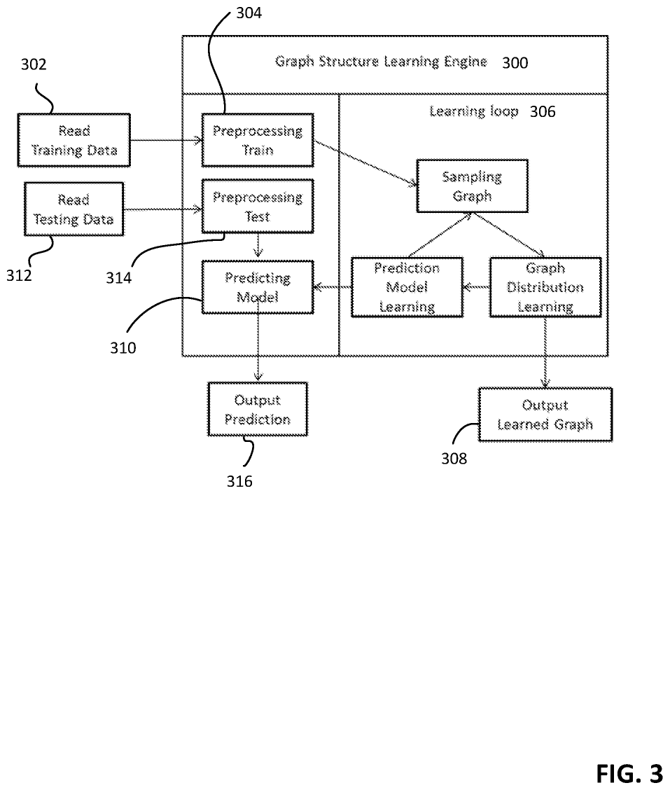

FIG. 3 is a block diagram of functions that processing system 400 can perform given method 200. The functions can operate as a graph structure learning engine 300. At block 302, processing system 400 can read training data. At block 304, processing system 400 can preprocess the training data. At block 306, processing system 400 can perform a learning loop on the preprocessed training data where processing system 400 can build a probabilistic distribution and iteratively update the prediction model and distribution parameters (e.g., the hyper-parameters) as described above for method 200. From the learning loop at block 306, processing system 400 can output a learned graph structure (block 308) and a prediction model (block 310). The learned structure can be a graph while the prediction model can be configured to perform predictions on the nodes of the graph.

At block 312, processing system 400 can accept testing data. At block 314, processing system 400 can preprocess the testing data. At block 316, processing system 400 can use the prediction model extracted from block 310 to generate a prediction.

Additional and exemplary features of method 200, learning engine 300, and processing system 400 are described in “On Learning Discrete Structures”, which is filed with the present application and hereby incorporated by reference.

Exemplary applications of processing system 400 (and thus method 200 and learning engine 300) are described below.

### First Example

In the medical and biomedical domains, patient data such as time series data and doctors' notes as well as data about biological processes is collected at a large scale and with high velocity. Graph-based machine learning can turn the available data into insights about patients and their conditions. For instance, patient outcome prediction is one major application where a graph connecting similar patients can be first constructed and then graph neural networks are applied to predict patient properties.

Examples of such patient properties are the medical condition (diagnosis) and the likelihood of the patient passing away within a particular timeframe (patient mortality prediction). The constructed graph can set patients as nodes and define edges between similar (according to some set of criteria) patients.

Through embodiments of the present disclosure, a graph can be learned and tailored to a particular prediction problem. The learned graph can improve prediction accuracy and reveal, through inspection of its edges, relationships between various patients. Existing heuristics can be used to create an initial graph structure, and embodiments of the disclosure can then alter the graph structure to find missing but beneficial relationships between patients.

### Second Example

In the retail market, shop owners aim to maximizing their profit through selecting the set of products offered at their stores. The sales of one product can affect the sales of others, and the sales at some shops are affected, sometimes, and correlated, other times, with the sales in similar shops (similarity can be based on space and/or type).

Product sales can be predicted by formulating the sales of each product at each store as a time series (task). Using method 200, processing system 400 can learn the graph for the graph based multi-task regression. The number of tasks can be in the order of the number of shops by the number of products. Through this approach, retail demand prediction can be efficiently solved, since the detection of similarities between tasks (using the learned graph) assists in collapsing the number of tasks while still respecting their correlation.

The advantage of applying the disclosed embodiments to retail problems, compared with other techniques, is that the disclosed embodiments can be configured to find the correct relationship between tasks; Therefore, these embodiments achieve a better predictive performance, since they exploit the correlations in the retail market between the different products and the different stores. Embodiments of processing system 400 are efficient to train even for large number of tasks; therefore, the model can be updated whenever there are new data points collected.

### Third Example

Consider a set of routes connecting the different parts of a city. Each route Rᵢ can consist of nᵢ stops. Let the set Pᵢⱼ be the set of realizations of the route Rᵢ, i.e., the set of actually travelled routes. Depending on the data collected from Automatic Passenger Counting (APC) and Automatic Vehicle Location (AVL) systems, the number of boarding and alighting travelers can be collected at each bus stop, besides the time of the vehicle arrival and departure. With this approach, the following problems can be formulated and solved:

Demand prediction at a given location/stop: For this problem the task can be formulated at the level of location/stop and an instance of a task can be each realization of each trip that passes through that stop. The target of each task can be the prediction of the number of passengers that are willing to board at this stop. The set of all available stops formulates all tasks that might share some properties (spatial closeness) and causality affects (as in the case of consecutive stops).

Travel time prediction: Similar to the previous problem, the target prediction of the task can be the time a trip requires reaching a given stop, given the features of the trip, route, and time.

Demand prediction at the origin-destination level: In the private transportation sector that is not restricted to pre-defined routes, such as taxis and car sharing, the origin-destination matrix can be reformulated in order to be used by processing system 400 (i.e., in method 200). To this end, each origin-destination pair can be considered as a task, which leads to quadratic number of tasks, in terms of the number of regions. This formulation can be best handled by method 200, since the clustering step reduces the number of tasks and exploits their correlations.

For these three prediction problems, defined in scope of intelligent transportation, method 200 can be applied (i.e., processing system 400 can be applied) to learn the graph for the graph based multi-task regression. Processing system 400 can do so by finding automatically the balance between learning each task (trip) separately and learning all tasks (trips) as a single problem. Processing system 400 can find the right relationship between the tasks (trips), while respecting the similarities between similar groups (of trips). Processing system 400 can be efficient to train even for large number of tasks; therefore, the model can be updated in real time.

### Example 4

Neural networks are both computationally intensive and memory intensive, making them difficult to deploy on embedded systems. Processing system 400 can be used to learn a sparse computational graph for a neural network. Therefore, processing system 400 can reduce the storage and computation required by neural networks by an order of magnitude without impairing accuracy by learning which connections are important in a systematic way. This makes it possible to deploy the trained neural network on embedding systems, e.g. a cell phone.

Referring to FIG. 4, processing system 400 can include one or more processors 402, memory 404, one or more input/output devices 406, one or more sensors 408, one or more user interfaces 410, and one or more actuators 412.

Processors 402 can include one or more distinct processors, each having one or more cores. Each of the distinct processors can have the same or different structure. Processors 402 can include one or more central processing units (CPUs), one or more graphics processing units (GPUs), circuitry (e.g., application specific integrated circuits (ASICs)), digital signal processors (DSPs), and the like. Processors 402 can be mounted on a common substrate or to different substrates.

Processors 402 are configured to perform a certain function, method, or operation at least when one of the one or more of the distinct processors is capable of executing code (including scripts), stored on memory 404 embodying the function, method, or operation. Processors 402, and thus processing system 400, can be configured to perform any and all functions, methods, and operations disclosed herein.

For example, when the present disclosure states that processing system 400 performs/can perform task “X”, such a statement should be understood to disclose that processing system 400 can be configured to perform task “X”. Processing system 400 are configured to perform a function, method, or operation at least when processors 402 are configured to do the same.

Memory 404 can include volatile memory, non-volatile memory, and any other medium capable of storing data. Each of the volatile memory, non-volatile memory, and any other type of memory can include multiple different memory devices, located at multiple distinct locations and each having a different structure.

Examples of memory 404 include a non-transitory computer-readable media such as RAM, ROM, flash memory, EEPROM, any kind of optical storage disk such as a DVD, a Blu-Ray® disc, magnetic storage, holographic storage, an HDD, an SSD, any medium that can be used to store program code in the form of instructions or data structures, and the like. Any and all of the methods, functions, and operations described in the present application can be fully embodied in the form of tangible and/or non-transitory machine-readable code (e.g., scripts) saved in memory 404.

Input-output devices 406 can include any component for trafficking data such as ports, antennas (i.e., transceivers), printed conductive paths, and the like. Input-output devices 406 can enable wired communication via USB®, DisplayPort®, HDMI®, Ethernet, and the like. Input-output devices 406 can enable electronic, optical, magnetic, and holographic, communication with suitable memory 406. Input-output devices 406 can enable wireless communication via WiFi®, Bluetooth®, cellular (e.g., LTE®, CDMA®, GSM®, WiMax®, NFC®), GPS, and the like. Input-output devices 406 can include wired and/or wireless communication pathways.

Sensors 408 can capture physical measurements of environment and report the same to processors 402. User interface 410 can include displays (e.g., LED touchscreens (e.g., OLED touchscreens), physical buttons, speakers, microphones, keyboards, and the like. Actuators 412 can enable processors 402 to control mechanical forces.

Processing system 400 can be distributed. Processing system 400 can have a modular design where certain features have a plurality of the aspects shown in FIG. 4. For example, I/O modules can include volatile memory and one or more processors.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

We claim:

1. A computer-implemented method comprising:
providing a data set arranged into multiple nodes;
assigning a random variable and a hyper-parameter to at least one pair of the multiple nodes, the hyper-parameter defining a current probability distribution of the random variable;
causing the random variable to occupy a discrete state based on the current probability distribution;
sampling a graph structure for the data set based on the discrete state;
adjusting a weight of a prediction model based on the sampled graph structure;
estimating a gradient of the hyper-parameter based on the sampled graph structure and the adjusted weight;
adjusting the hyper-parameter based on the estimated gradient;
resampling a graph structure for the data set based on the adjusted hyper-parameter; and
assigning a final graph structure to the data set based on the resampled graph structure.

2. The method of claim 1, wherein the random variable is a Bernoulli variable configured to occupy a first discrete state and a second discrete state with a frequency based on a value of the hyper-parameter.

3. The method of claim 2, wherein the first discrete state corresponds to a presence of an edge extending between the pair of nodes and the discrete second state corresponds to an absence of an edge extending between the pair of nodes.

4. The method of claim 1, wherein a random variable and a hyper-parameter defining a current probability distribution of the random variable are assigned to each possible pair of the multiple nodes such that a total quantity of the random variables is equal to a total quantity of the hyper-parameters, which exceeds a total quantity of the nodes.

5. The method of claim 1, wherein providing the data set arranged into multiple nodes comprises:
preprocessing an unstructured data set, the preprocessing comprising data normalization;
extracting features from the preprocessed data set and assigning each of the extracted features to one or more nodes based on a location from which the feature was extracted.

6. The method of claim 1, wherein the causing of the random variable to occupy the discrete state, the sampling of the graph structure, and the adjusting of the prediction model weight define an inner loop and the method comprises:
performing the inner loop multiple times such that the weight of the prediction model is adjusted multiple times based on multiple sampled graph structures; and
estimating the gradient of the hyper-parameter based on the multiple sampled graph structures and the multiple adjustments to the weight.

7. The method of claim 1, wherein the prediction model is a neural network and the method comprises classifying a subsequent data set with the neural network.

8. The method of claim 1, wherein the prediction model is a neural network comprising neurons and the weight of the neural network is adjusted by training the neural network with a predetermined set of training data.

9. The method of claim 8, wherein the gradient of the hyper-parameter is defined with respect to a cost function of the neural network.

10. A processing system comprising one or more processors configured to:
provide a data set arranged into multiple nodes;
assign a random variable and a hyper-parameter to at least one pair of the multiple nodes, the hyper-parameter defining a current probability distribution of the random variable;
cause the random variable to occupy a discrete state based on the current probability distribution;
sample a graph structure for the data set based on the discrete state;
adjust a weight of a prediction model based on the sampled graph structure;
estimate a gradient of the hyper-parameter based on the sampled graph structure and the adjusted weight;
adjust the hyper-parameter based on the estimated gradient;
resample a graph structure for the data set based on the adjusted hyper-parameter; and
assign a final graph structure to the data set based on the resampled graph structure.

11. The processing system of claim 10, wherein the one or more processors are configured to cause the random variable to occupy a first discrete state and a second discrete state with a frequency based on a value of the hyper-parameter.

12. The processing system of claim 10, wherein the one or more processors are configured such that the first discrete state corresponds to a presence of an edge extending between the pair of nodes and the discrete second state corresponds to an absence of an edge extending between the pair of nodes.

13. The processing system of claim 10, wherein the one or more processors are configured such that a random variable and a hyper-parameter defining a current probability distribution of the random variable are assigned to each possible pair of the multiple nodes such that a total quantity of the random variables is equal to a total quantity of the hyper-parameters, which exceeds a total quantity of the nodes.

14. The processing system of claim 10, wherein the one or more processors are configured to provide the data set arranged into the multiple nodes by:
(a) receiving the data set arranged into the multiple nodes through a communications platform, or
(b) preprocessing an unstructured data set, the preprocessing comprising data normalization; and extracting features from the preprocessed data set and assigning each of the extracted features to one or more nodes based on a location from which the feature was extracted.

15. A computer program embodied on at least one non-transitory computer-readable medium, the computer program comprising instructions to cause one or more processors to:
provide a data set arranged into multiple nodes;
assign a random variable and a hyper-parameter to at least one pair of the multiple nodes, the hyper-parameter defining a current probability distribution of the random variable;
cause the random variable to occupy a discrete state based on the current probability distribution;
sample a graph structure for the data set based on the discrete state;
adjust a weight of a prediction model based on the sampled graph structure;
estimate a gradient of the hyper-parameter based on the sampled graph structure and the adjusted weight;
adjust the hyper-parameter based on the estimated gradient;
resample a graph structure for the data set based on the adjusted hyper-parameter; and
assign a final graph structure to the data set based on the resampled graph structure.
